(19) United States
(12) Patent Application Publication
(10) Pub. No.: US 2010/0287096 A1
(43) Pub. Date: Nov. 11, 2010

(54) SYSTEM AND METHOD FOR FACILITATING A VALUE EXCHANGE TRANSACTION

(76) Inventor: Daniel K. Leul, Hyattsville, MD (US)

Correspondence Address: FITCH, EVEN, TABIN & FLANNERY, P. O. BOX 18415, WASHINGTON, DC, 20036, US

(21) Appl. No.: 12/095,060

(22) PCT Filed: Aug. 28, 2006
(86) PCT No.: PCT/US06/33484

§ 371 Date: Aug. 2, 2010

Related U.S. Application Data
(60) Provisional application No. 60/711,361, filed on Aug. 26, 2005.

(51) Int. Cl. G06Q 40/00

(52) U.S. Cl. 705/42

(57) ABSTRACT

A method and system of facilitating a value exchange solely telephonically and preferably using IVR between multiple users in a distributed value exchange system. The method involves registering a first user with the value exchange system, wherein the first user is assigned a first account within the value exchange system; receiving telephonically at the value exchange system a value exchange transaction from the first user, wherein said transaction involves a second user and includes an identifier of the second user, a separate security code, and a value to be exchanged between the first user and the second user; and at the value exchange system prompting the first user to independently send a notification of said value exchange transaction to the second user and debiting said value from one of said first account to a credit to a second account associated with the second user as a pending transaction. Additional features of the present invention optionally add voice pattern recognition to validate the identity of a user and IVR to allow easy access to anyone with any type of telephone. A specific feature of the system to improve security is independent notification of a pending transaction.

### CLAIM OF PRIORITY

This Application claims priority to and the benefit of U.S. Provisional Application No. 60/711,361, filed Aug. 26, 2005, which is incorporated by reference herein in its entirety.

### FIELD OF THE INVENTION

The present invention generally relates to a system and method for facilitating a value exchange transaction, and more specifically, to a system and method for facilitating a value exchange transaction using a cellular telephone, independent transaction notification, and optionally interactive voice response/recognition (“IVR”).

### BACKGROUND OF INVENTION

Electronic means are known in the art to facilitate money transactions. Money transfers have rapidly evolved from cash and checks to credit cards and debit cards. Several banks now also provide electronic bill payment using the Internet. Such payment systems involve setting up individual or recurring payments, where an individual orders a bank to pay for goods or services to specific individuals, often by providing account numbers or other specific identifiers of the payee.

One such system, under the service name of PAYPAL (PayPal, Inc., Mountain View, Calif.), is a method of electronic value exchange using email and the like. This has created opportunities for many to share the benefit of an electronic payment system which was not provided by the bank. Further, electronic payment systems have also been developed using, in part, “smart” telephone technology (i.e., having e-mail and Internet access) as an access point to a computer provider.

Unfortunately, there is not known in the art a system and method to provided value exchange transactions using solely telephone technology, wired or wireless. Such systems would allow users with cell phones or wired telephones to participate in value exchange transactions without the need to access an e-mail or Internet site. Such system and method would be particularly useful in some areas of the United States and in developing countries where Internet and e-mail access may be limited to many in the population. Thus, there is a desire and a need in the art to develop a value exchange transaction system and method without the need for Internet or e-mail access.

### SUMMARY OF INVENTION

Accordingly, the present invention provides a method and system of telephonically facilitating a value exchange between multiple users in a distributed value exchange system. The method involves registering a first user with the value exchange system, wherein the first user is assigned a first account within the value exchange system; receiving telephonically at the value exchange system a value exchange transaction from the first user, wherein said transaction involves a second user and includes an identifier of the second user, a separate security code, and a value to be exchanged between the first user and the second user; and at the value exchange system, prompting the first user to independently send a notification of said value exchange transaction to the second user, and debiting said value from one of said first account to a credit to a second account associated with the second user as a pending transaction.

Additional features of the present invention further add registering the second user with the value exchange system, if not already registered, and using a telephone number as a pre-existing identifier; use of voice pattern recognition to validate the identity of a user, and IVR to allow easy access to anyone with any type of telephone.

The advantage of the present invention is the ability to perform the value exchange transaction using mobile communication devices, such as cell phones.

A specific feature of the system to improve security is independent notification of a pending transaction. Such notification may be telephonic, e-mail, text-message, and the like. It is anticipated that most users will use their telephone for the notification so that Internet usage is not needed to complete a transaction.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figures below, in which like numerals represent elements, and in which:

FIG. 1 is a block diagram depicting a system for conducting value exchange transactions in accordance with an embodiment of the present invention; and

FIG. 2 is a flowchart illustrating one method of conducting a value exchange transaction in accordance with an embodiment of the present invention.

### DETAILED DESCRIPTION OF THE INVENTION

The program environment in which a present embodiment of the invention is executed illustratively incorporates a general-purpose computer, a special purpose device such as a hand-held computer used in conjunction with telephonic communication devices including, but not limited to, cellular telephone and traditional wired telephones. Details of such devices (e.g., processor, memory, data storage, display, wired/wireless communication capability) are omitted for the sake of clarity and are known in the art. Computer program or computer program product in the present context means any expression, in any language, code, or notation, of a set of instructions intended to cause a system having an information processing capability to perform a particular function, either directly or after either or both of the following: (a) conversion to another language, code, or notation, and (b) reproduction in a different material or electronic form.

It should also be understood that the techniques of the present invention might be implemented using a variety of technologies. For example, the methods described herein may be implemented, in addition to telephonic technology, in software executing on a computer system or implemented in hardware utilizing either a combination of microprocessors or other specially designed application-specific integrated circuits, programmable logic devices, or various combinations thereof. In particular, the methods described herein may be implemented by a series of computer-executable instructions residing on a storage medium such as a carrier wave, disk drive, or computer-readable medium. Exemplary forms of carrier waves may take the form of electrical, electromagnetic or optical signals conveying digital data streams along a local network or a publicly accessible network, such as the Internet.

In one embodiment of the invention, a system and method are provided for facilitating an exchange of value between two or more persons using client telephonic devices. Values that are exchanged may be monetary in nature (using any currency) or may take other forms, such as credits, debits, discounts, vouchers (e.g., for gasoline), certificates, mileage (e.g., frequent flier miles), gift cards, etc. The telephonic devices used to facilitate an exchange transaction may be portable in nature and may employ virtually any communication media, including both wired and wireless. In one implementation of this embodiment, at least one user employs a cellular telephone. A communicative device suitable for this embodiment links, on demand, to another device (e.g., a system server), such as a networked personal computer.

A system according to this embodiment of the invention includes at least one highly accessible computer server configured to facilitate value exchanges. Illustratively, a user who wishes to initiate a value exchange or value transfer with another party is registered with the server beforehand (e.g., an account is established for the user on the server). The other party may or may not be a registered user at the time the transaction is initiated or communicated to the system.

In one method of conducting a value exchange according to this embodiment of the invention, an entity involved in the exchange may be known by an identifier that has meaning or use outside of the system, such as a telephone number with caller ID enabled. Illustratively, such identifier is only associated with one person or entity, thus promoting accountability. In an alternative method, however, multiple users or accounts may be associated with an identifier.

In one implementation of a method of conducting a value exchange, a registered user of the system initiates an exchange with an unregistered party by identifying that party to the system server by his or her telephone number. The registered user may provide various details of the value exchange, such as the form of the value (e.g., a monetary amount, a number of credits, or affinity points), a date on which to effect the transfer, the unregistered party's telephone number, established security code, and the like. The system may then independently attempt to contact the unregistered party (e.g., via the provided telephone number), notify him or her of the value exchange, identify the initiating user, and invite the unregistered party to connect to the server and close the exchange. The unregistered party may be required to register with the system in order to close the transaction. For example, if the value exchange is to the benefit of the unregistered user, he or she may wish to leave the value in the system in order to use it to conduct an exchange with yet another party. Alternatively, the unregistered party may be permitted to provide just enough information (e.g., credit card number, address) to allow the system to close the transaction without being registered. It is noted that, minimally, the invention may be practiced with only the security code needed to complete the transaction.

In different embodiments of the invention, the value exchange may be initiated by the person who owes or is owed the value to be exchanged. Further, the value that is exchanged may be of virtually any form and/or may be transformed in nature. For example, a monetary amount or a credit or voucher held by a first user and accepted by a second user may be transferred from the first user to the second user in exchange for goods or services. Or, the value may change from one currency to another or from being monetary in nature to being represented by credits with a merchant, frequent flier miles, or some other value. Thus, a user may pay for goods or services with value in many different forms, including currency or points that are used only within the system (e.g., for transactions between users).

The system may also be configured to allow users to perform normal banking operations (e.g., withdrawals, deposits, transfers), stock transactions, electronic ticketing, and the like. In another embodiment of the invention, a third party may be involved to hold the value in escrow until a transaction is closed.

Value may be introduced into the system (and credited to a user's account) from various financial institutions via cash, check, debit, or virtually any other method that is presently used or that becomes accepted in the business community, such as financial and transactional services sold under the service name of WESTERN UNION (Western Union Holdings, Inc., Greenwood Village, Colo.). Value may exit the system in these and similar forms.

Generally, the present invention uses telephonic communications, including cellular phone systems readily accessible to the public in the United States and in other countries (including developing countries). In short, smart phone technology is not needed to practice the present invention. One use of the present invention is the buying and selling of prepaid phone cards over the phone.

Using optional interactive voice recognition/response (“IVR”) technology, solely cell phones can do electronic money transfers. The logic used and the security feature described herein may have the following major units:

Opening account—call to the system, accept terms and conditions, create a pass code; Sending money—call to the system, choose send money option, provide the recipient phone number, create a security code, provide the amount, confirm the transaction;

Receiving money—call to the system, provide the security code; Canceling a wrong money transfer—call to the system, choose cancel wrong money transfer option, provide the telephone number;

Funding account—call to the system, choose fund account option, choose the payment method (credit card, check card, check, and the like); answer all security questions, enter amount;

Taking cash out of the account—call to the system, choose take out cash option, choose the payment method (check, bank transfer, credit card credit, and the like), enter amount, confirm the transaction;

Checking account balance—call to the system, choose check account balance; and

Selling prepaid phone cards—call to the system, choose card type, choose amount, and confirm the transaction.

The system and method of the present invention can be designed to sell prepaid phone cards and other services using pin numbers. For example, in Europe, a user may purchase electricity in local stores selling prepaid cards with a pin number. In Europe, you can buy electricity in local stores selling prepaid cards with pin number.

Other advantages of the system and method of the present invention are apparent. Using solely telephonic communications to complete a value exchange transaction is a simple form of payment and easily accessible to most of the population, even in developing countries. In developing countries, the telephone network has been built in a very short time. Establishing cash service units similar to those sold under the service name WESTERN UNION is an ideal solution. The system can be used to establish these units which can do bill payment service.

### One Embodiment of a System and Method of the Present Invention for Facilitating a Value Transfer

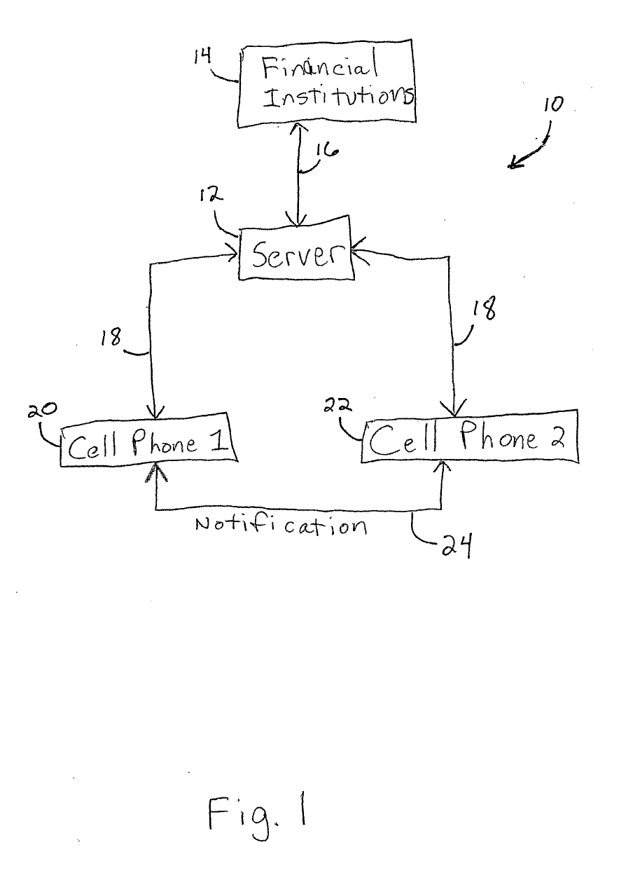

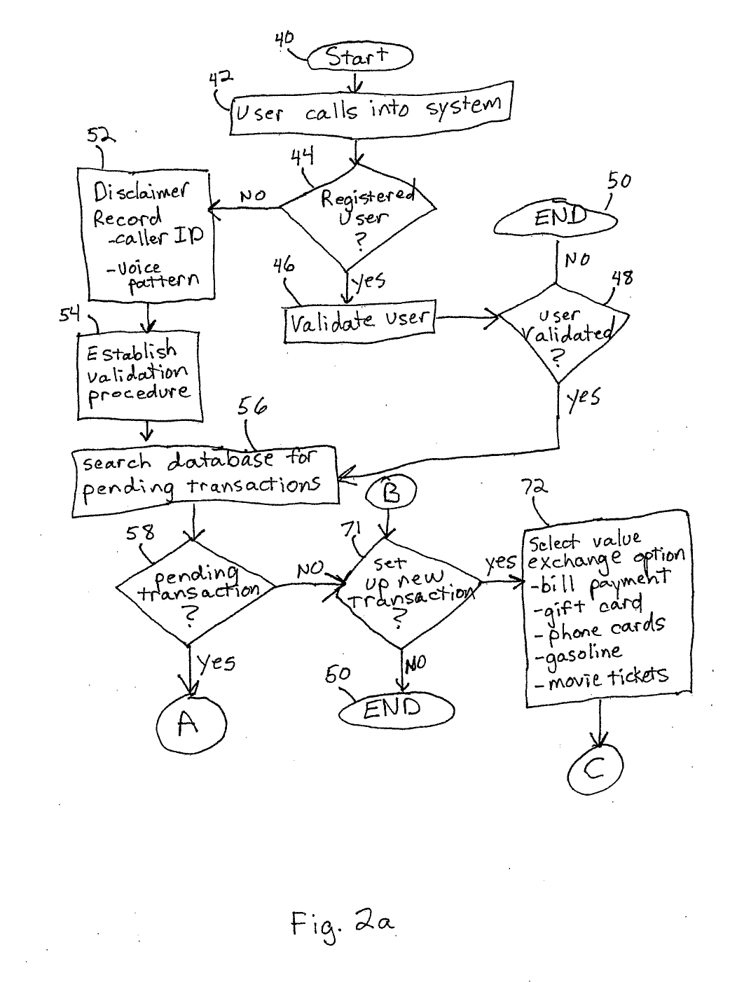

FIG. 1 depicts an illustrative system for facilitating value transfers according to one embodiment of the invention generally indicated at 10. Alternative embodiments of the invention may incorporate any subset of the components of the illustrated system.

System 10 of FIG. 1 includes a computing device 12 (Server) acting as a financial server having a central database, which is configured to store various information used to facilitate value exchange transactions. Illustratively, the information stored in the database can include accounts for registered users of the system, as well as various information pertaining to unregistered users participating in or invited to participate in a transaction. User information for registered and/or unregistered users may include user identifiers (e.g., name, electronic mail address, telephone number, network address, physical address), transaction records, account balances in one or more different forms (e.g., money, frequent flier miles, store credits, affinity points, vouchers, coupons, discounts), preferred communication methods (e.g., electronic mail, wireless voice), security data, and the like.

In the system of FIG. 1, Server 12 database is communicatively connected at 16 to a financial institution 14. In this embodiment, Server 12 and/or any other optional system servers are configured to interact at 16 with financial institutions 14 by way of Internet, telephone switch, DSLAM (Digital Subscriber Line Access Multiplexer), and the like. Server 12 may cooperate with one or more internal or external databases to ensure or enforce security for value exchanges and actions related to value exchanges. Server 12 can also allow a user to register with the system, access and/or modify account information, conduct and clear transactions, etc. A user may be required, however, to register with System 10 before being able to initiate or close a transaction.

Server 12 is configured to interface with one or more financial institutions which may, in one embodiment of the invention, be external to the system. Thus, Server 12 may interact with credit card companies, banks (including traditional and online banks), and other entities that handle or process value in suitable forms; in particular, the financial server may be configured to transfer funds through the ACH (Automated Clearing House) or companies providing similar services, such as WESTERN UNION. Server 12 may be configured to automatically generate a charge or credit to a user's account with an external financial institution when the user's system account balance falls below or rises above a predetermined threshold. Further, the external value that the system can access for a user through financial server 108 may affect the number of transactions that the user can conduct or the amount of value in a transaction.

Server 12 may serve as a primary access point to System 10 for new and existing users. Server 12 may be telephonically connected network presence to users at 18. Illustratively, users are given account names, for example by caller ID, and passwords/security codes with which to access System 10 after being registered. Other forms of security (e.g., digital certificates, biometric devices, IVR) may be employed in other embodiments of the invention. Thus, users can be identified by the cell phone used to access the system, as shown at 20 and 22. As shown, 20 and 22 are also telephonically connected at 24.

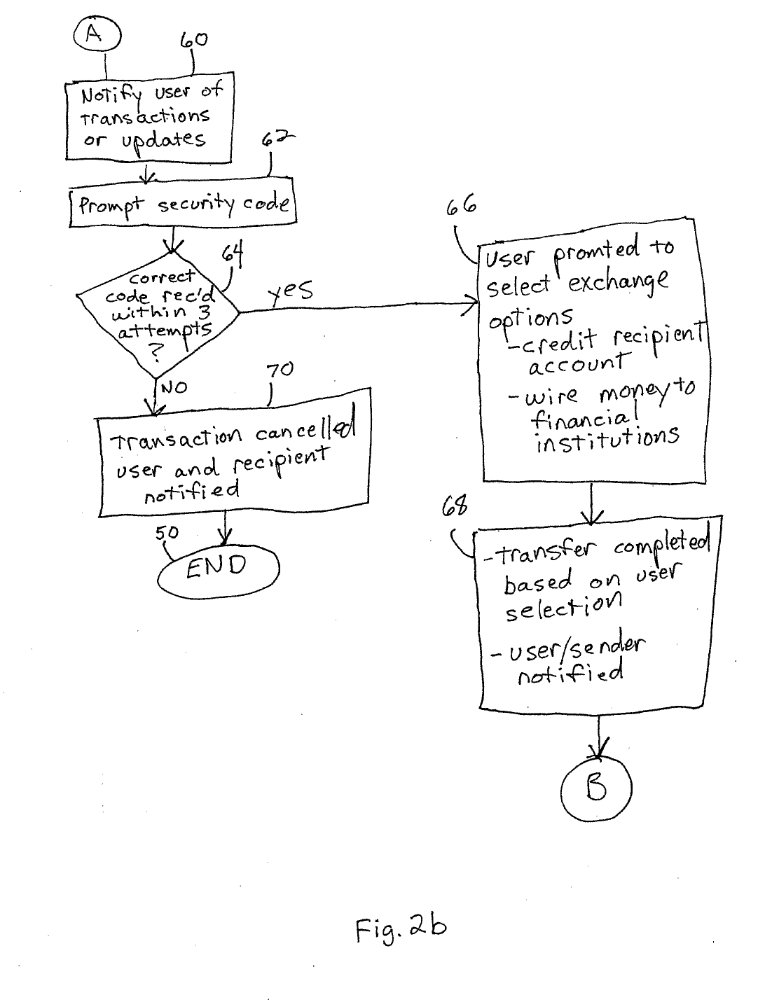

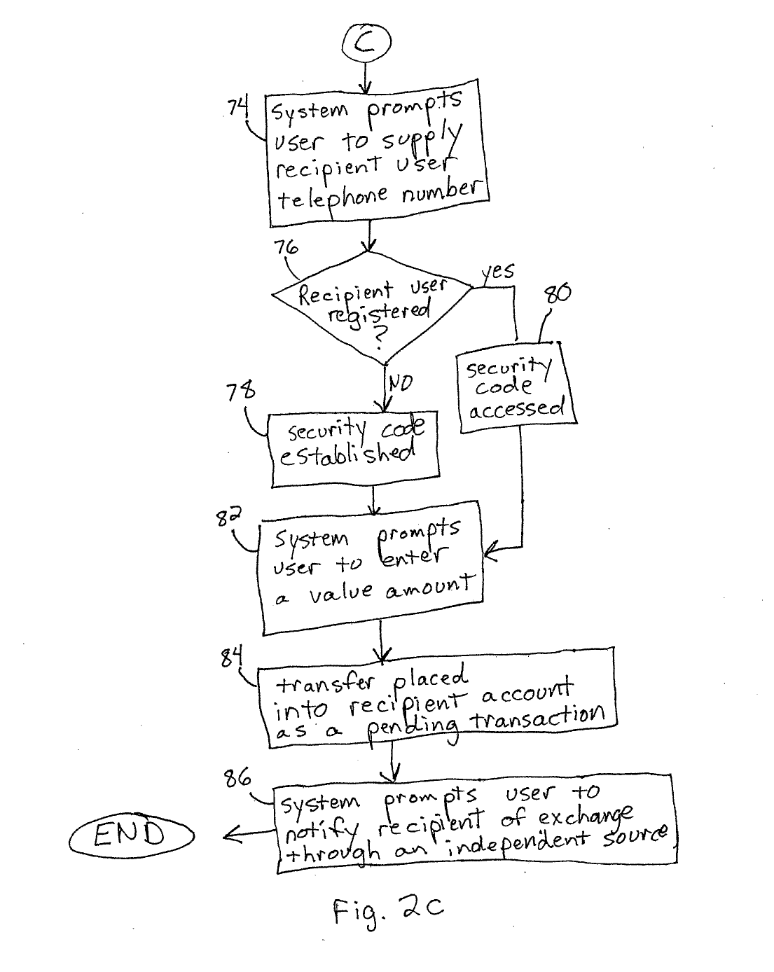

Referring now to FIG. 2, there is shown a flow of a system that embodies the objectives of the present invention. The system starts at Step 40 and proceeds to Step 42 when a user telephonically calls into the system. Based on information from the caller, such as the caller ID of the call, the system determines at Step 44 whether the call is coming from a registered user. If yes, the system proceeds to Step 46 to validate the user. This may be through any of, or in any combination of, voice pattern recognition, assigned or predetermined security codes, and the like. If the user is not validated at step 48, the system proceeds to END 50. If the user is validated at Step 48, the system proceeds to Step 56.

If at Step 44 the system determines the call is not coming from a potentially registered user, the system proceeds to Step 52 for introductory information. Such information can include a disclaimer regarding the system, storing the caller ID information into Server 12 database, and optionally recording voice pattern of the user. The system may next proceed to Step 54 to the next user account setup information of establishing a validation process. This may be through any of, or in any combination of, voice pattern recognition, assigned or predetermined security codes, and the like. Such security codes may optionally be provided by the value exchange sender and are communicated to the recipient outside of the system, such as through a direct call to the recipient. Other ways to communicate a security code could be through e-mail, text message, voice mail, and the like. It is noted that when a new account is opened, a sender security code is not needed. The security code from the sender is when a user wants to clear a pending transaction.

The system next proceeds to Step 58 to determine whether a value exchange transaction is currently pending for this user. If no, the system proceeds to Step 71. If yes, the system proceeds to Step 60 and notifies the user of the pending transaction. The system next proceeds to Step 62 and prompts the user to provide the proper security code. If the correct code is not received within three or fewer attempts at Step 64, the system proceeds to Step 70, where the transaction is cancelled, and the user/sender and recipient are notified of the cancellation. The system then proceeds to END 50. If the correct code is received within three or fewer attempts, the system may proceed to optional Step 66.

At optional Step 66, the system prompts the user to select among available options to receive the value exchange transaction. Such options may include credit to the user account with the database of Server 12 or transfer the value to a predetermined or selected Financial Institution 14. When a selection is received the system proceeds to Step 68 to complete the value exchange as directed and optionally notifies the sender and/or recipient that the transfer has been completed. Although not shown, the system would determine whether additional pending transactions are also pending, until none were found.

After Step 68 is completed, the system returns to Step 71. At Step 71, the user is prompted to indicate whether they would like to set up a new value exchange transfer. If no, the system proceeds to END 50. If yes, the system proceeds to Step 72 and prompts the user to select the type of value exchange transaction they wish to set up. Such exchange transaction could be numerous and limited only to the technology available to the system. By way of example only, such transaction could include any number of bill payment options, gift card purchase, cellular telephone pin numbers (e.g., phone cards), electricity pin numbers, gasoline or other commodity purchase, movie ticket purchase, and the like. Once a selection is made by user, the system proceeds to Step 74. At Step 74, the system prompts the user to supply information regarding the recipient. Minimally, this would include the recipient's telephone number.

Once recipient information is supplied to the system, the system determines whether the recipient is a registered user at Step 76. If yes, a security code or validation process is accessed (or established) at Step 80, then proceeds to Step 82. If no, the system proceeds to Step 78, where a security code or validation process is established before proceeding to Step 82. At Step 82, the system prompts the user to minimally enter a value amount for the transaction, which is next placed in Server 12 database as a pending transaction at Step 84. Additional information, such as date(s) of availability of the transaction or any other qualifiers known in the art, could also be applied. Next, the system proceeds to prompt the user to notify the recipient of the exchange at Step 86 though a communication outside of the system, such as voicemail, text message, voice call, e-mail, and the like. Alternatively, the system could arrange to make the notification, but the independent notification adds security to the transaction.

In an alternate embodiment (not shown), the system my also add different classes of registered users. For example, the system could add a step after step 76 to determine whether the recipient is a “special” customer. If yes, then the system could notify the sender of the recipient information and then skip to Step 82. This would assist payments to some large or corporate providers. For example, if the sender wishes to make a payment to a cell phone carrier, the carrier could have a special registration in the system that would allow receipt of payment without a security code. It would not be practical for the carrier to call to the system and complete the money transfer by providing the security code. Rather, the system would notify the sender that the receiver is a “special” customer and skip to Step 82 without a security code.

The description of the present invention herein is presented to enable any person skilled in the art to make and use the invention and is provided in the context of particular applications of the invention and their requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method of telephonically facilitating a value exchange between multiple users in a distributed value exchange system, the method comprising:
registering a first user with the value exchange system, wherein the first user is assigned a first account within the value exchange system;
receiving telephonically at the value exchange system a value exchange transaction from the first user, wherein said transaction involves a second user and includes an identifier of the second user, a separate security code, and a value to be exchanged between the first user and the second user; and
at the value exchange system, prompting the first user to independently send a notification of said value exchange transaction to the second user and debiting said value from one of said first account to a credit to a second account associated with the second user as a pending transaction.

2. The method of claim 1, further comprising registering the second user with the value exchange system, if not already registered.

3. The method of claim 1, wherein said pre-existing identifier is a telephone number.

4. The method of claim 1, wherein said value exchange transaction is received from the first user through a mobile communication device.

5. The method of claim 4, wherein the mobile communication device is a telephone.

6. The method of claim 1, further comprising converting said value to be exchanged between the first user and the second user from a first form to a second form.

7. The method of claim 1, further comprising repeating the method for a second value exchange transaction between the second user and a third user.

8. The method of claim 1, wherein the independent notification is telephonic.

9. The method of claim 1, wherein the independent notification is by e-mail.

10. The method of claim 1, wherein the independent notification is by text-message.

11. The method of claim 1, further comprising creating said second account and registering the second user.

12. The method of claim 1, further comprising the step of validating a user.

13. The method of claim 12, wherein the step of validating uses voice pattern recognition.

14. The method of claim 1, further comprising IVR technology to facilitate telephonic communication.

15. A computer and telephonic system for facilitating an exchange of value between multiple users through a distributed transaction system separate from the multiple users, the system comprising:
a value exchange system, wherein a first user is assigned a first account within the value exchange system;
a value exchange transaction from the first user by telephone, wherein said transaction involves a second user and includes an identifier of the second user, a separate security code, and a value to be exchanged between the first user and the second user; and
at the value exchange system, a prompt from the first user to independently send a notification of said value exchange transaction to the second user and debiting said value from one of said first account to a credit to a second account associated with the second user as a pending transaction.

16. A computer readable storage medium storing instructions that, when executed by a computer based on telephonic prompting, cause the computer to perform a method of facilitating a value exchange between multiple users in a distributed value exchange system, the method comprising:
registering a first user with the value exchange system, wherein the first user is assigned a first account within the value exchange system;
receiving telephonically at the value exchange system a value exchange transaction from the first user, wherein said transaction involves a second user and includes an identifier of the second user, a separate security code, and a value to be exchanged between the first user and the second user; and
at the value exchange system, prompting the first user to independently send a notification of said value exchange transaction to the second user and debiting said value from one of said first account to a credit to a second account associated with the second user as a pending transaction.
